(19) United States
(12) Patent Application Publication
(10) Pub. No.: US 2026/0145438 A1
(43) Pub. Date: May 28, 2026

(54) PRINTING APPARATUS

(71) Applicant: SEIKO EPSON CORPORATION, TOKYO (JP)

(72) Inventors: Yoshiyuki TANAKA, MATSUMOTO-SHI (JP); Takaho NAGUMO, MATSUMOTO-SHI (JP); Mugio KAWASAKI, SUWA-SHI (JP); Yasuhiro TAGUCHI, SHIMOSUWA-MACHI (JP); Daisuke KANUMA, MATSUMOTO-SHI (JP)

(21) Appl. No.: 19/400,218

(22) Filed: Nov. 25, 2025

(30) Foreign Application Priority Data
Nov. 26, 2024 (JP) 2024-205237

(51) Int. Cl. B41J 3/46; B41J 2/175; B41J 13/10; B41J 29/13; H04N 1/00

(52) U.S. Cl. CPC B41J 3/46; B41J 2/17543; B41J 2/17566; B41J 13/106; B41J 29/13; H04N 1/00326; H04N 1/00392; H04N 1/0062

(57) ABSTRACT

A printing apparatus includes an internal discharge unit, an operation unit, and a reading unit capable of housing a reading device. The operation unit and the reading unit are located above the internal discharge unit and are disposed side by side in the left-right direction in front view. A medium discharge direction of the internal discharge unit is one direction of the left direction and the right direction in front view. The operation unit is located in the other direction of the left direction and the right direction with respect to the reading unit in front view. The operation unit is located outside a region of the internal discharge unit in plan view and at least a part of the reading unit is located outside the region of the internal discharge unit. The operation unit and the reading unit respectively face upward.

The present application is based on, and claims priority from JP Application Serial Number 2024-205237, filed Nov. 26, 2024, the disclosure of which is hereby incorporated by reference herein in its entirety.

### BACKGROUND

### 1. Technical Field

The present disclosure relates to a printing apparatus.

### 2. Related Art

For example, an image forming apparatus described in JP-A-2015-43494 includes an operation unit, an internal paper discharge unit, and a card reader in an apparatus main body. The image forming apparatus is an example of a printing apparatus. The operation unit is provided at the end portion on one side in the left-right direction of the apparatus main body, the internal paper discharge unit is provided to open a part on the other side in the left-right direction of the apparatus main body, and the card reader is provided on the other side further in the left-right direction than the operation unit.

JP-A-2015-43494 is an example of the related art.

However, in the image forming apparatus described in JP-A-2015-43494, since the card reader is retracted to the back with respect to the operation unit, it is difficult to hold an IC card over the card reader.

### SUMMARY

According to an application example of the present disclosure, there is provided a printing apparatus including: a conveyance unit configured to convey a printing medium; a printing head configured to perform printing on the printing medium conveyed by the conveyance unit; an apparatus main body housing the conveyance unit and the printing head; an internal discharge unit formed in the apparatus main body, the printing medium conveyed by the conveyance unit being discharged to the internal discharge unit; an operation unit provided in the apparatus main body and configured to receive input of operation by a user; and a reading unit capable of housing a reading device configured to read information from an information medium storing the information, the reading unit being provided in the apparatus main body, wherein the operation unit and the reading unit are located above the internal discharge unit in an up-down direction and are disposed side by side in a left-right direction of the apparatus main body in front view, a medium discharge direction of the printing medium in the internal discharge unit is one direction of a left direction and a right direction in front view, the operation unit is located in another direction of the left direction and the right direction with respect to the reading unit in front view, in plan view, the operation unit is located outside a region of the internal discharge unit and at least a part of the reading unit is located outside the region of the internal discharge unit, and the operation unit and the reading unit respectively face upward.

### BRIEF DESCRIPTION OF THE DRAWINGS

FIG. 1 is a perspective view of a printing apparatus according to a first embodiment.

FIG. 2 is a schematic cross-sectional view illustrating a conveyance unit in the printing apparatus according to the first embodiment.

FIG. 3 is a front view illustrating the periphery of a reading unit in the printing apparatus according to the first embodiment.

FIG. 4 is a plan view of the printing apparatus according to the first embodiment.

FIG. 5 is a left side view illustrating the periphery of an operation panel in the printing apparatus according to the first embodiment.

FIG. 6 is a right side view illustrating the periphery of the reading unit in the printing apparatus according to the first embodiment.

FIG. 7 is a perspective view illustrating the reading unit in the printing apparatus according to the first embodiment.

FIG. 8 is a left side view illustrating the periphery of a document supply and discharge device in the printing apparatus according to the first embodiment.

FIG. 9 is a front view illustrating the periphery of a viewing window in the printing apparatus according to the first embodiment.

FIG. 10 is a plan view of a printing apparatus according to a second embodiment.

FIG. 11 is a front view illustrating the periphery of a document supply and discharge device in a printing apparatus according to a third embodiment.

### DESCRIPTION OF EMBODIMENTS

### First Embodiment

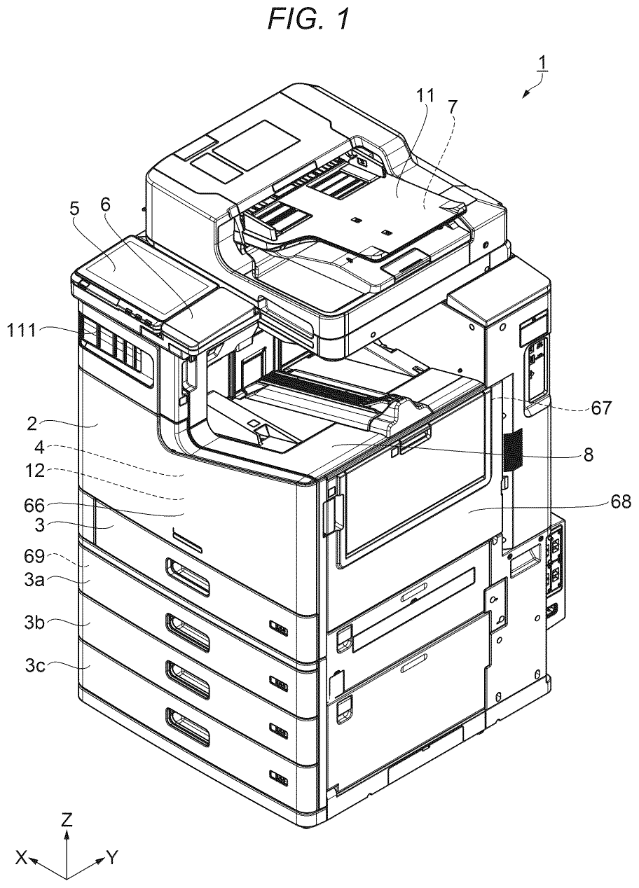

A printing apparatus 1 according to a first embodiment is explained with reference to FIGS. 1 to 9.

For convenience of explanation, an X axis, a Y axis, and a Z axis are illustrated in the figures as three axes orthogonal to one another. A direction along the X axis is referred to as “X-axis direction”, a direction along the Y axis is referred to as “Y-axis direction”, and a direction along the Z axis is referred to as “Z-axis direction”. An arrow side of the axes is also referred to as “positive side” and a side opposite to the arrow is also referred to as “negative side”. A plan view in the Z-axis direction is also referred to simply as “plan view”.

An X-axis direction is a width direction of the apparatus, and a +X direction is a left direction and a −X direction is a right direction when viewed from an operator of the printing apparatus 1. The X-axis direction is also referred to as left-right direction. The Y-axis direction is a depth direction of the printing apparatus 1. A +Y direction is a direction from the operator toward the printing apparatus 1 and is also referred to as back direction. A −Y direction is a direction from the printing apparatus 1 toward the operator and is also referred to as front direction. Viewing the printing apparatus 1 from the −Y side is also simply referred to as “front view”. The Z-axis direction is the vertical direction, that is, the height direction of the apparatus. A +Z direction is the upward direction and a −Z direction is the downward direction. The operator is equivalent to a user.

The printing apparatus 1 is, for example, an inkjet printer that performs printing by ejecting ink onto a printing medium P represented by printing paper.

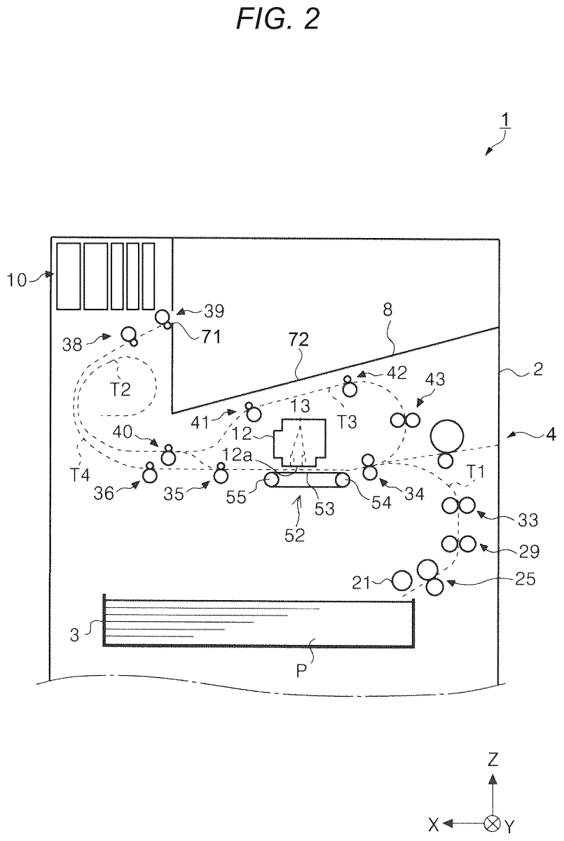

A schematic configuration of the printing apparatus 1 is explained. As illustrated in FIGS. 1 and 2, the printing apparatus 1 includes a conveyance unit 4, a printing head 12, an apparatus main body 2, an internal discharge unit 8, an operation panel 5, and a reading unit 6. The operation panel 5 is equivalent to an operation unit. The apparatus main body 2 houses the conveyance unit 4 and the printing head 12. Among side surfaces of the printing apparatus 1, the side surface on the +Y side is a back surface 67, the side surface on the −Y side is a front surface 66, the side surface on the +X side is a left side surface 69, and the side surface on the −X side is a right side surface 68.

A specific example of the present disclosure is explained below. As illustrated in FIG. 2, the conveyance unit 4 conveys the printing medium P. The printing head 12 performs printing on the printing medium P conveyed by the conveyance unit 4. Hereinafter, a direction in which the printing medium P is sent is sometimes referred to as “downstream” and a direction opposite to the direction is sometimes referred to as “upstream”. In the printing apparatus 1, the printing medium P is conveyed through paths T1 to T4.

The printing apparatus 1 includes a medium cassette 3 in a lower part of the apparatus main body 2 including the printing head 12 explained below. For the medium cassette 3, a pickup roller 21 that delivers the printing medium stored therein in the −X direction is provided. For the medium cassette 3, a feed roller pair 25 that feeds, further downstream, the printing medium P delivered by the pickup roller 21 is provided. A plurality of medium cassettes 3a, 3b, and 3c (see FIG. 1) are further provided below the medium cassette 3. A pickup roller (not illustrated) and a feed roller pair (not illustrated) are provided for each of the plurality of medium cassettes 3a, 3b, and 3c. Note that, in the following explanation, it is assumed that, unless particularly explained otherwise, a “roller pair” includes a driving roller driven by a power source such as a motor and a driven roller driven to rotate in contact with the driving roller.

The conveyance unit 4 includes the medium cassette 3, the pickup roller 21, the feed roller pair 25, conveyance roller pairs 29, 33 to 36, and 38 to 43, and a belt unit 52.

A conveyance path T1 is a conveyance path for the printing medium P delivered from the medium cassette 3 and reaching the conveyance roller pair 34. The printing medium P delivered from the medium cassette 3 receives sending forces from the conveyance roller pairs 29 and 33 and is sent to the conveyance roller pair 34. The printing medium P that receives the sending force from the conveyance roller pair 34 is sent to between the printing head 12 and a conveyance belt 53, that is, to a printing position facing the printing head 12.

The printing head 12 ejects ink onto the printing medium P from a nozzle 13 provided on a nozzle surface 12a to execute printing. In the present embodiment, an ejection direction of the ink from the nozzle 13 is the downward direction. In the printing head 12, a plurality of nozzles 13 that eject ink are disposed to cover the entire region in the width direction of the printing medium P. The printing head 12 is a line-type inkjet head that enables printing in the width entire region of the printing medium P without involving movement in the width direction of the printing medium P. However, an inkjet head is not limited thereto and may be a type that is mounted on a carriage and ejects ink while moving in the width direction of the printing medium P. Further, a printing scheme is not limited to an inkjet scheme and may be a dot impact scheme or an electrophotographic scheme such as a laser scheme or an LED scheme.

The printing head 12 according to the present embodiment ejects inks of a plurality of colors as an example. In the present embodiment, the plurality of nozzles 13 include a plurality of nozzles 13 that eject yellow ink, a plurality of nozzles 13 that eject magenta ink, a plurality of nozzles 13 that eject cyan ink, and a plurality of nozzles 13 that eject black ink. Furthermore, the plurality of nozzles 13 that eject the black ink include a plurality of nozzles 13 that eject black dye ink and a plurality of nozzles 13 that eject black pigment ink.

Subsequently, the conveyance belt 53 is an endless belt wound around a first roller 54, which is a driving roller, and a second roller 55, which is a driven roller. The conveyance belt 53 rotates when the first roller 54 is driven by a belt rotation motor (not illustrated). The printing medium P is conveyed at a position facing the printing head 12 while being attracted to a belt surface of the conveyance belt 53.

The first roller 54, the second roller 55, and the conveyance belt 53 configure the belt unit 52. The belt unit 52 is an example of a support unit that supports the printing medium P. The belt unit 52 includes the first roller 54 as a turning shaft and is provided to be turnable by power of a belt moving motor (not illustrated). When the belt unit 52 turns, the conveyance belt 53 moves between a support position facing the printing head 12 and a retracted position (not illustrated) separated from the support position.

The printing medium P, on a first surface of which printing has been performed by the printing head 12, is sent toward either the conveyance roller pair 36 or the conveyance roller pair 40 by the conveyance roller pair 35 located downstream of the conveyance belt 53. A not-illustrated path switching flap is provided downstream of the conveyance roller pair 35. The printing medium P receiving the sending force from the conveyance roller pair 35 is sent to either the conveyance roller pair 36 or the conveyance roller pair 40 by the path switching flap.

When printing is performed on the first surface of the printing medium P and printing is not performed on a second surface opposite to the first surface, that is, when duplex printing is not performed, the printing medium P is sent from the conveyance roller pair 35 toward the conveyance roller pair 36. The printing medium P sent from the conveyance roller pair 35 toward the conveyance roller pair 36 is conveyed to a discharge port 71 provided in the apparatus main body 2 passing through a discharge path T4. The conveyance roller pair 38 and the conveyance roller pair 39 are disposed in the discharge path T4.

When printing is performed on both of the first surface and the second surface opposite to the first surface of the printing medium P, that is, when the duplex printing is performed, the printing medium P is sent from the conveyance roller pair 35 toward the conveyance roller pair 40 and enters a switchback path T2. Thereafter, a rotating direction of the conveyance roller pair 40 is switched and the printing medium P enters a reversal path T3 and is sent to the conveyance roller pair 34 by the conveyance roller pairs 41, 42, and 43.

The printing head 12 performs printing on the second surface of the printing medium P sent to the conveyance roller pair 34. The printing medium P, on the second surface of which the printing has been performed, is sent from the conveyance roller pair 35 toward the conveyance roller pair 36 and conveyed to the discharge port 71 provided in the apparatus main body 2 passing through the discharge path T4.

The printing medium P conveyed to the discharge port 71 is discharged from the discharge port 71 and placed on a placement surface 72 of the apparatus main body 2. The placement surface 72 is a part of a surface that sections the internal discharge unit 8 as explained below. Therefore, the printing medium P conveyed by the conveyance unit 4 is discharged to the internal discharge unit 8.

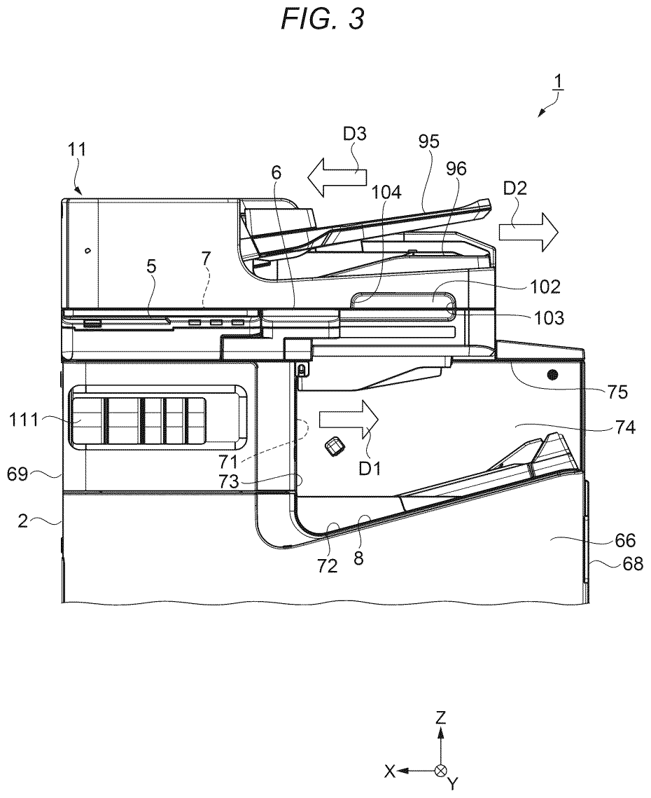

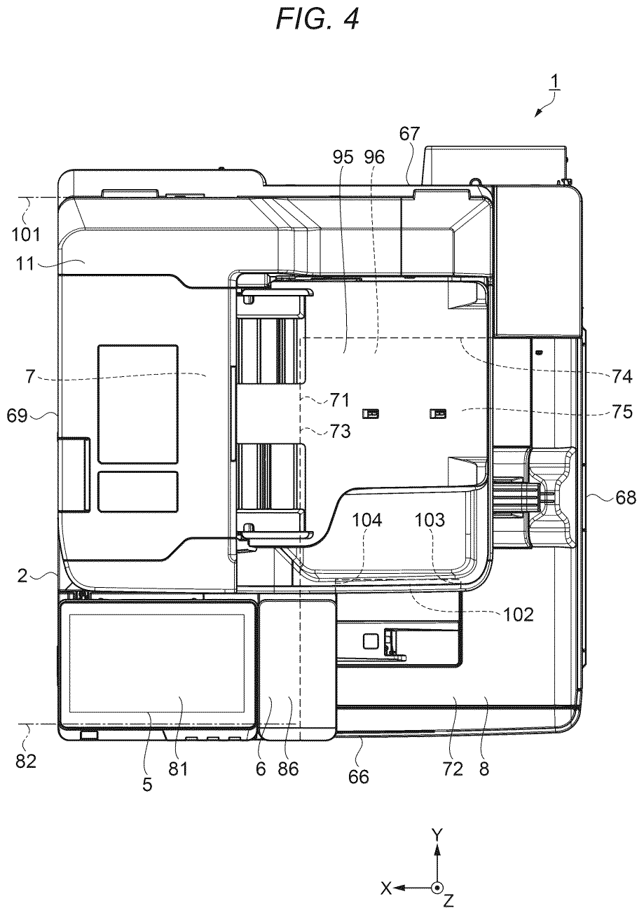

As illustrated in FIGS. 3 and 4, the internal discharge unit 8 is formed in the apparatus main body 2. The apparatus main body 2 includes a first wall surface 73, a second wall surface 74, and a ceiling surface 75. The first wall surface 73 includes the discharge port 71. The first wall surface 73 faces the right direction, that is, the −X direction. The second wall surface 74 is coupled to the first wall surface 73 and the placement surface 72. The second wall surface 74 faces the front direction, that is, the −Y direction. The ceiling surface 75 faces the placement surface 72. The ceiling surface 75 faces downward, that is, in the −Z direction. The internal discharge unit 8 is a space sectioned by the placement surface 72, the first wall surface 73, the second wall surface 74, an imaginary plane including the ceiling surface 75, an imaginary plane including the front surface 66 of the apparatus main body 2, and an imaginary plane including the right side surface 68 of the apparatus main body 2. The internal discharge unit 8 is located on the right side with respect to the discharge port 71. The internal discharge unit 8 is provided to open parts in the front direction, the right direction, and the upward direction of the apparatus main body 2. As illustrated in FIG. 3, a medium discharge direction D1 of the printing medium P in the internal discharge unit 8 is the right direction in front view. With the configuration explained above, it is easy to take out the printing medium P with the right hand.

As illustrated in FIG. 4, in plan view, the internal discharge unit 8 is a region surrounded by the first wall surface 73, the second wall surface 74, the contour of the front surface 66 in the apparatus main body 2, and the contour of the right side surface 68 in the apparatus main body 2. In plan view, the contour of the front surface 66 in the apparatus main body 2 overlaps the end side in the front direction in the placement surface 72. In plan view, the contour of the right side surface 68 in the apparatus main body 2 overlaps the end side in the right direction in the placement surface 72.

If the first wall surface 73 is inclined with respect to a plane parallel to the up-down direction and the depth direction, if the first wall surface 73 includes unevenness, or if the first wall surface 73 includes a curved portion, the first wall surface 73 has width in the left-right direction in plan view. If the second wall surface 74 is inclined with respect to a plane parallel to the up-down direction and the left-right direction, if the second wall surface 74 includes unevenness, or if the second wall surface 74 includes a curved portion, the second wall surface 74 has width in the depth direction in plan view. In the case explained above, the region of the internal discharge unit 8 in plan view is defined such that the area of the region is maximized. That is, in plan view, the end portion of the internal discharge unit 8 in the left-right direction is defined on the left side surface 69 side most and the end portion of the internal discharge unit 8 in the depth direction is defined on the back surface 67 side most.

The operation panel 5 receives input of operation by the user. Based on the input received by the operation panel 5, the printing apparatus 1 performs printing on the printing medium P and discharges the printing medium P to the internal discharge unit 8.

As illustrated in FIGS. 1, 3, and 4, the operation panel 5 is provided in the apparatus main body 2 and is located above the apparatus main body 2. The operation panel 5 is located above the ceiling surface 75 in the up-down direction. That is, the operation panel 5 is located above the internal discharge unit 8 in the up-down direction. In plan view, the operation panel 5 is located further on the left side than the first wall surface 73. That is, the operation panel 5 is located outside the region of the internal discharge unit 8 in plan view. The end portion on the left side of the operation panel 5 is located to be aligned with the left side surface 69 in plan view. The end portion on the front surface 66 side of the operation panel 5 is located to be aligned with the front surface 66 in plan view. As illustrated in FIG. 4, the operation panel 5 includes an operation surface 81 that receives input of the user. In FIG. 4, the operation surface 81 faces upward. With the configuration explained above, the operator can execute, without moving a standing position, work of inputting to the operation panel 5 and work of taking out the printing medium P from the internal discharge unit 8. The operation panel 5 overlaps the apparatus main body 2 in plan view. Accordingly, it is possible to prevent the operator or a person moving near the printing apparatus 1 from colliding with the operation panel 5.

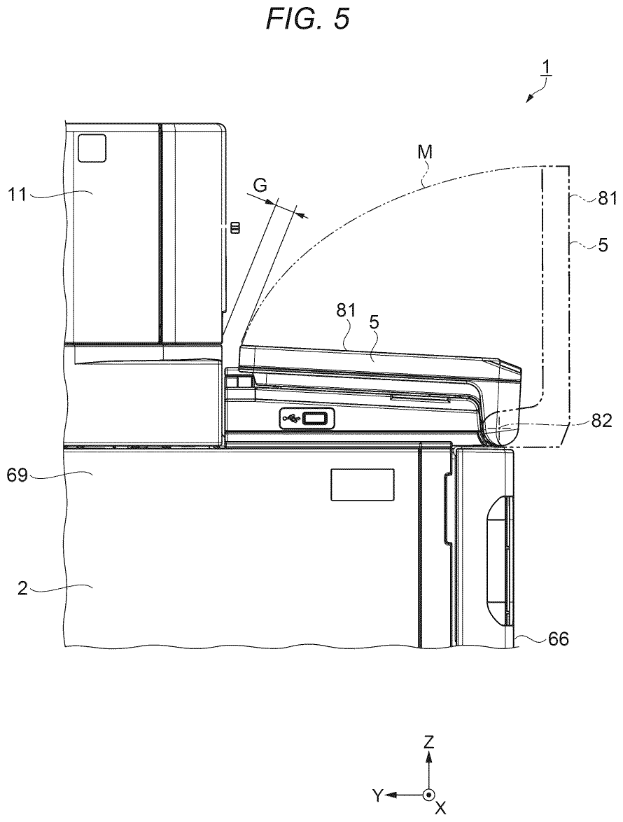

As illustrated in FIG. 5, the operation panel 5 includes a tilt shaft 82 and is capable of tilting around the tilt shaft 82 with respect to the apparatus main body 2. The tilt shaft 82 is disposed at the end portion on the front surface 66 side in the operation panel 5 and extends in the left-right direction. When the operation panel 5 tilts, the direction in which the operation surface 81 faces can be changed between the upward direction and the front direction. The operation panel 5 indicated by a solid line in FIG. 5 faces upward. Note that the operation panel 5 facing upward means that the perpendicular direction of the operation surface 81 has an upward component. The operation surface 81 is a surface that the operator faces when performing operation. Since the operation panel 5 tilts, the operation can be facilitated.

As illustrated in FIG. 4, the operation panel 5 has a rectangular shape having long sides extending in the left-right direction when viewed in the perpendicular direction of the operation surface 81. With the configuration explained above, since the operator has the eyes provided in the left-right direction, the visibility of the operation surface 81 can be improved.

The reading unit 6 performs user authentication by reading specific information stored in an IC card owned by the user and comparing the read specific information and user information stored in advance. The IC card is an example of an information medium.

As illustrated in FIGS. 1, 3, and 4, the reading unit 6 is provided in the apparatus main body 2. The reading unit 6 is located above the ceiling surface 75 in the up-down direction. That is, the reading unit 6 is located above the internal discharge unit 8 in the up-down direction. The reading unit 6 is located above the apparatus main body 2 and is arranged side by side with the operation panel 5 in the left-right direction in front view. The reading unit 6 is located in the right direction with respect to the operation panel 5. The reading unit 6 overlaps the first wall surface 73 in plan view. That is, a part of the reading unit 6 is located outside the region of the internal discharge unit 8 in plan view. In other words, a part of the reading unit 6 overlaps the region of the internal discharge unit 8 in plan view. With the configuration explained above, the visibility and the easiness in taking out of the printing medium P in the internal discharge unit 8 are less easily impaired. In addition, it is easy to avoid the increase in the width of the printing apparatus 1 in the left-right direction.

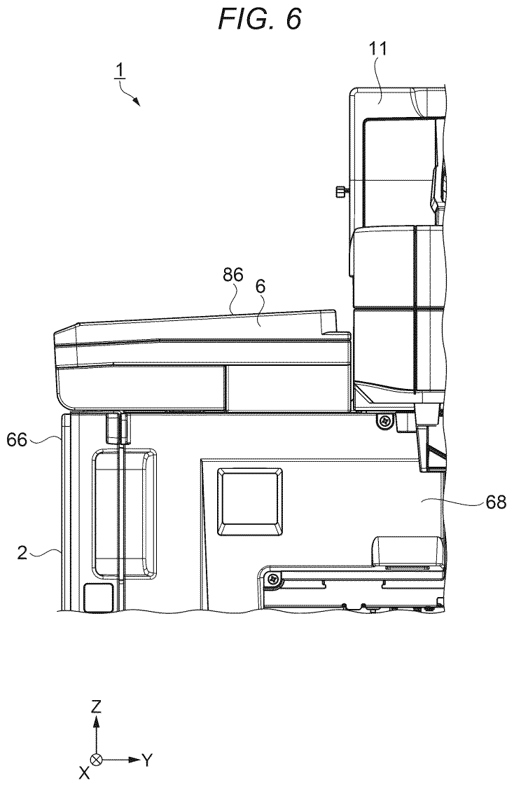

As illustrated in FIGS. 4 and 6, the reading unit 6 includes a reading surface 86 serving as a surface on which the operator holds an IC card. The reading surface 86 faces upward. With the configuration explained above, the operator can execute, without moving a standing position, work of causing the IC card to access the reading unit 6 and work of taking out the printing medium P from the internal discharge unit 8.

As illustrated in FIG. 3, the reading unit 6 is located in the right direction with respect to the operation panel 5 and the medium discharge direction D1 is also the right direction in front view. With the configuration explained above, it is easy to access the reading unit 6 with the right hand and take out the printing medium P.

As illustrated in FIG. 4, the reading unit 6 has a rectangular shape having short sides extending in the left-right direction when viewed in the perpendicular direction of the reading surface 86. The length of the long sides of the reading unit 6 is equal to the length of the short sides of the operation panel 5. The end portion on the front surface 66 side of the reading unit 6 is located to be aligned with the front surface 66 of the apparatus main body 2 in plan view. That is, the reading unit 6 overlaps the apparatus main body 2 in plan view. Accordingly, it is possible to prevent the operator or a person moving near the printing apparatus 1 from colliding with the reading unit 6.

The operation panel 5 and the reading unit 6 respectively face upward. The reading unit 6 facing upward means that the perpendicular direction of the reading surface 86 has an upward component. With the configuration explained above, it is easy to cause the IC card to access the reading unit 6 and operation of avoiding the operation panel 5 is unnecessary. Since the operation panel 5 is located outside the region of the internal discharge unit 8 and at least a part of the reading unit 6 is located outside the region of the internal discharge unit 8 in plan view, the visibility and the easiness in taking out of the printing medium P in the internal discharge unit 8 are less easily to be impaired.

As illustrated in FIGS. 1, 3, and 4, when the operation panel 5 faces upward, the difference between the height of the operation surface 81 and the height of the reading surface 86 is small. That is, the difference in the position in the up-down direction of the reading surface 86 with respect to the operation surface 81 is small. With the configuration explained above, it is possible to smoothly shift from the operation of causing the IC card to access the reading surface 86 to the work of operating the operation panel 5. Therefore, a series of work can be easily performed. In addition, since the facing direction of the operation surface 81 and the facing direction of the reading surface 86 are aligned, a series of work can be more easily performed.

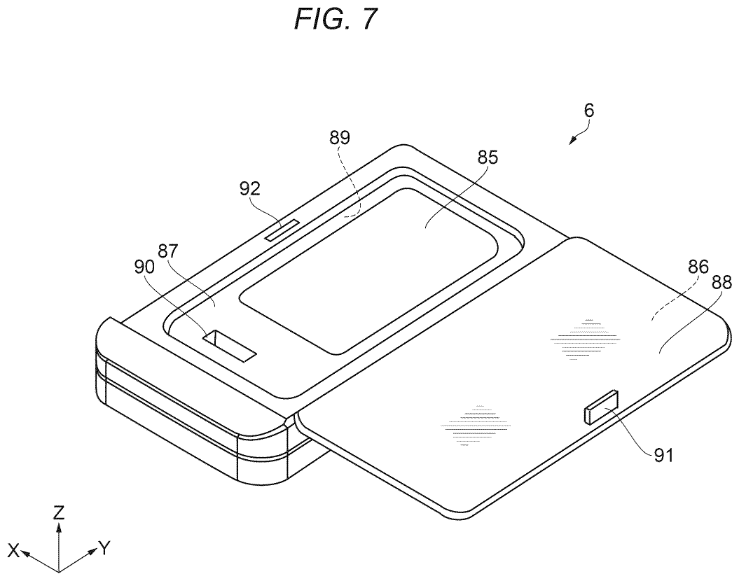

As illustrated in FIG. 7, the reading unit 6 includes a device housing unit 87 and a cover 88. The device housing unit 87 is capable of housing the card reader 85. The card reader 85 is a device that reads information from an IC card in which the information is stored and is equivalent to a reading device. In FIG. 7, the card reader 85 is housed in the device housing unit 87. The cover 88 covers the device housing unit 87. When the IC card is held over the reading surface 86, communication is performed between the IC card and the card reader 85 via the reading surface 86. The device housing unit 87 includes a recess 89 in which the card reader 85 is housed. The card reader 85 can be attached to and detached from the reading unit 6 by an administrator of the printing apparatus 1.

The cover 88 is openable and closable with respect to the device housing unit 87 and is covering the card reader 85 in a closed state. In the state in which the cover 88 is closed, the surface of the cover 88 is the reading surface 86. The surface of the cover 88 is a surface on the side opposite to the surface of the cover 88 facing the card reader 85. The reading unit 6 in the present embodiment includes a hinge parallel to the depth direction. The cover 88 opens and closes by swinging centering on an axis parallel to the depth direction. The material of the cover 88 is not particularly limited only if communication is possible via the cover 88 and is hard plastic as an example. With the configuration explained above, it is possible to prevent the card reader 85 from being damaged or from being stained.

The reading unit 6 includes locking units 91 and 92. The cover 88 can be locked by the locking units 91 and 92 in a state of covering the device housing unit 87. With the configuration explained above, it is possible to prevent the card reader 85 from being stolen or the card reader 85 from being detached by a person other than the administrator. A locking method is not particularly limited and may be, for example, a method using a turning hook, a method using a padlock, a dial method, or an electromagnetic lock method.

A connector 90 to which a wireless communication dongle can be electrically coupled is provided on the inside of the device housing unit 87. Accordingly, a wireless communication dongle for adding a wireless communication function to the printing apparatus 1 can be coupled. The coupling of the wireless communication dongle is executed in a state in which the cover 88 is opened with respect to the device housing unit 87.

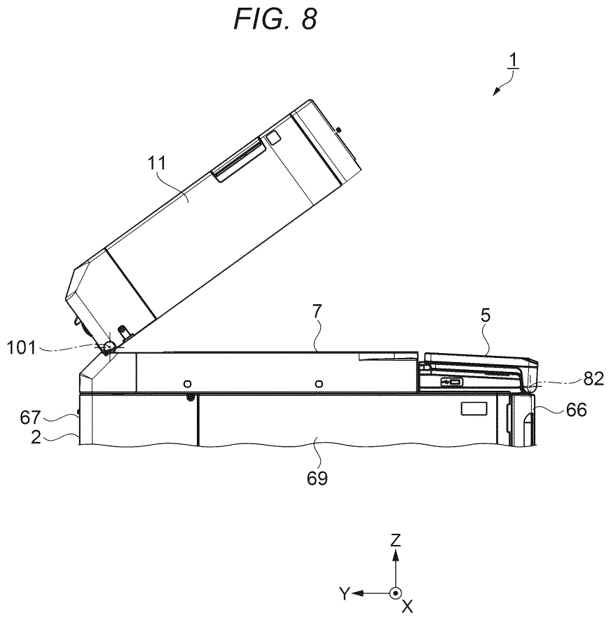

As illustrated in FIG. 8, the printing apparatus 1 further includes an image reading device 7 disposed above the apparatus main body 2. As illustrated in FIGS. 1, 3, 4, and 8, the printing apparatus 1 further includes a document supply and discharge device 11 disposed above the image reading device 7. The image reading device 7 is configured to be capable of reading images such as characters and photographs printed on a document. The document supply and discharge device 11 is configured to be capable of supplying and discharging a document toward the image reading device 7.

As illustrated in FIG. 3, the document supply and discharge device 11 includes a document conveyance unit (not illustrated), a document supply tray 95, and a document discharge tray 96. The document conveyance unit supplies a document placed on the document supply tray 95 to the image reading device 7 and further discharges the read document to the document discharge tray 96. The document supply tray 95 is disposed above the document discharge tray 96. The document supply tray 95 and the document discharge tray 96 are disposed on the right side with respect to the document conveyance unit. As illustrated in FIGS. 3 and 4, the document supply tray 95 and the document discharge tray 96 partially overlap the internal discharge unit 8 in plan view.

As illustrated in FIG. 3, a document discharge direction D2 of the document supply and discharge device 11 is the right direction. The document discharge direction D2 is the same as the medium discharge direction D1 of the printing medium P in the internal discharge unit 8. With the configuration explained above, the printing medium P discharged to the internal discharge unit 8 and the document discharged to the document supply and discharge device 11 can be taken out by the same hand.

A document setting direction D3 of the document supply and discharge device 11 is the left direction. The document setting direction D3 is a direction opposite to the document discharge direction D2. With the configuration explained above, the operator can easily take out the document discharged to the document supply and discharge device 11 with a hand that has set the document on the document supply and discharge device 11. That is, work from the document setting to the document taking out is facilitated. In particular, facing the front surface 66, the operator can easily set the document on the document supply tray 95 with the right hand and take out the document from the document discharge tray 96 with the right hand.

As illustrated in FIG. 8, the document supply and discharge device 11 can be opened and closed with respect to the image reading device 7 by turning around a turning shaft 101. The document supply and discharge device 11 is opened when a document is directly placed on the image reading device 7. The turning shaft 101 extends in the left-right direction and is provided at the end portion in the back direction in the image reading device 7.

As illustrated in FIGS. 3 and 4, a grip section 102 is provided in the document supply and discharge device 11. The grip section 102 enables the operator to place his or her hand thereon when opening the document supply and discharge device 11. The grip section 102 is a recess provided at the end portion in the front direction of the document supply and discharge device 11 and extending in the left-right direction. The recess is opened in the front direction and downward. The grip section 102 is located in a region overlapping the internal discharge unit 8 in plan view. A right end portion 103 in the right direction and a left end portion 104 in the left direction of the grip section 102 are located on the right side with respect to the operation panel 5 and the reading unit 6 in the left-right direction.

With the configuration explained above, it is possible to urge a worker about to open or close the document supply and discharge device 11 in an erected state of the operation panel 5 to place his or her hand at a safe position. Accordingly, the worker is urged to pay attention such that a finger of the operator is not caught between the document supply and discharge device 11 and the operation panel 5. The operator does not need to avoid the operation panel 5 and the reading unit 6 when placing his or her hand on the grip section 102. Thus, it is possible to easily perform work of opening and closing the document supply and discharge device 11. The operator can perform, with the same hand, the work of opening and closing the document supply and discharge device 11 and the work of taking out the printing medium P present in the internal discharge unit 8.

As illustrated in FIGS. 4 and 8, the operation panel 5 explained above is disposed on the side opposite to the turning shaft 101 with respect to the document supply and discharge device 11. The tilt shaft 82 of the operation panel 5 is disposed on the side opposite to the document supply and discharge device 11 with respect to the operation panel 5. As illustrated in FIG. 5, when the operation panel 5 is tilted, a gap G is present between a locus M drawn by the end portion of the operation panel 5 on the side opposite to the tilt shaft 82 and the document supply and discharge device 11. The size of the gap G is big enough to fit a finger of a hand of the operator. With the configuration explained above, it is possible to improve workability at the time when the operator tilts the operation panel 5.

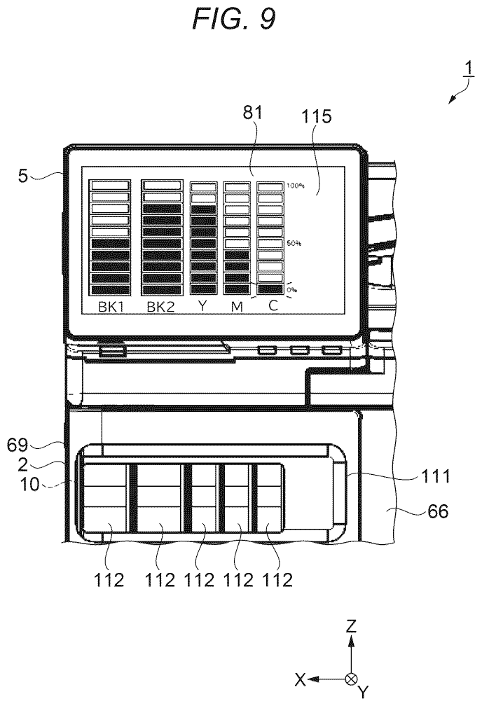

As illustrated in FIGS. 1 and 9, the apparatus main body 2 further includes an ink storage unit 10 and a viewing window 111. As illustrated in FIG. 9, an ink cartridge 112 storing ink supplied to the printing head 12 (see FIG. 2) can be attached to the ink storage unit 10. The ink cartridge 112 is detachably housed in the ink storage unit 10 of the apparatus main body 2. The viewing window 111 is formed on the front surface 66 of the apparatus main body 2. The user is capable of visually recognizing the ink storage unit 10 of the apparatus main body 2 through the viewing window 111. That is, the user is capable of visually recognizing, through the viewing window 111, the ink cartridge 112 attached to the ink storage unit 10 of the apparatus main body 2. The ink supplied to the printing head 12 is filled in the ink cartridge 112 for each type of ink. In the present embodiment, the type of the ink is a color of the ink. The ink supplied to the printing head 12 is stored in a different ink cartridge 112 for each color of ink. The viewing window 111 is provided below the operation panel 5 in front view. The viewing window 111 overlaps the ink storage unit 10 in front view. When a plurality of ink cartridges 112 are attached to the ink storage unit 10, it is possible to visually recognize, through the viewing window 111, that the plurality of ink cartridges 112 are disposed side by side in the left-right direction.

The apparatus main body 2 includes an ink cartridge unit cover (not illustrated) in which a part of a housing is opened and closed to open the ink storage unit 10. The ink storage unit 10 is opened to enable replacement work for the ink cartridge 112. A position where the ink cartridge unit cover is provided is not particularly limited and is, for example, the front surface 66 or the left side surface 69 of the apparatus main body 2. The ink cartridge unit cover may include the viewing window 111.

As illustrated in FIG. 9, the operation panel 5 includes a display unit 115 capable of displaying information concerning a remaining amount of the ink in the ink storage unit 10. In the present embodiment, the display unit 115 also serves as the operation surface 81. However, the display unit 115 is not limited thereto and may be, for example, a monitor that does not have an input function. The display unit 115 is located above the viewing window 111. The ink cartridge unit cover can be opened and closed even in a state in which the operation panel 5 is erected with respect to the apparatus main body 2. With the configuration explained above, it is possible to intuitively visually recognize the ink cartridge 112 that should be replaced among the plurality of ink cartridges 112. Accordingly, a time for replacement work can be reduced. It is possible to prevent a work mistake such as erroneous replacement.

The arrangement order in the left-right direction of pieces of information concerning the plurality of ink cartridges 112 displayed on the display unit 115 is the same as the arrangement order in the left-right direction of the plurality of ink cartridges 112 attached to the ink storage unit 10. Accordingly, it is possible to more intuitively visually recognize the ink cartridge 112 that should be replaced.

When the ink cartridge 112 is the same type, it is desirable that a position where the ink cartridge 112 is displayed on the display unit 115 and a position where the ink cartridge 112 is attached to the ink storage unit 10 are aligned in the up-down direction. Accordingly, since the movement of the line of sight of the operator or the worker who replaces the ink cartridge 112 can be reduced, it is possible to more intuitively visually recognize the ink cartridge 112 that should be replaced.

It is explained above with reference to FIG. 3 that the medium discharge direction D1 of the printing medium P in the internal discharge unit 8 is the right direction in front view and the operation panel 5 is located in the left direction with respect to the reading unit 6 in front view. However, the medium discharge direction D1 and the operation panel 5 are not particularly limited thereto. For example, the medium discharge direction D1 may be the left direction in front view and the operation panel 5 may be located in the right direction with respect to the reading unit 6 in front view. That is, the medium discharge direction D1 only has to be one direction of the left direction and the right direction in front view and the operation panel 5 only has to be located in the other direction of the left direction and the right direction with respect to the reading unit 6 in front view. With the configuration explained above, the same effects as the effects explained above can be obtained.

It is explained above that the operation panel 5 overlaps the apparatus main body 2 in plan view. However, the operation panel 5 is not particularly limited thereto. For example, a part of the operation panel 5 may protrude from the apparatus main body 2 in plan view. Accordingly, it is possible to improve a degree of freedom in disposition of the operation panel 5 with respect to the apparatus main body 2.

It is explained above that the operation panel 5 and the reading unit 6 overlap the apparatus main body 2 in plan view. However, the operation panel 5 and the reading unit 6 are not particularly limited thereto. For example, in plan view, a part of the operation panel 5 and a part of the reading unit 6 may respectively protrude from the apparatus main body 2 in the front direction. In this case, the operation surface 81 and the reading surface 86 only have to face upward. Accordingly, it is easy to cause an IC card to access the reading unit 6 and an operation of avoiding the operation panel 5 is unnecessary.

The IC card is explained as an example of the information medium above. However, the information medium is not particularly limited thereto. The information medium may be, for example, a smartphone or a smart watch adapted to near field communication.

It is explained above that the operation panel 5 is a rectangle having the long sides extending in the left-right direction when viewed in the perpendicular direction of the operation surface 81. However, the operation panel 5 is not particularly limited thereto. For example, the rectangle may have long sides extending in the depth direction when viewed in the perpendicular direction of the operation surface 81. Accordingly, it is possible to improve the operability of the operation panel 5. It is possible to increase an amount of information displayed on the display unit 115.

It is explained above that the reading unit 6 is the rectangle having the short sides extending in the left-right direction when viewed in the perpendicular direction of the reading surface 86. However, the reading unit 6 is not particularly limited thereto. For example, the rectangle may have short sides extending in the depth direction when viewed in the perpendicular direction of the reading surface 86. Accordingly, the operator can easily hold an IC card over the reading surface 86 in a state in which the long sides of the IC card are directed in the left-right direction.

It is explained above that the cover 88 provided in the reading unit 6 opens and closes by swinging. However, the cover 88 is not particularly limited thereto. For example, the cover 88 may open and close by sliding. The cover 88 may be detachably attachable to the device housing unit 87. Accordingly, the cover 88 can be replaced.

It is explained above that the operation panel 5 and the reading unit 6 are separately configured. However, the operation panel 5 and the reading unit 6 are not particularly limited thereto. For example, the operation panel 5 and the reading unit 6 may be integrally configured.

It is explained above that the document supply and discharge device 11 can be opened and closed with respect to the image reading device 7. However, the document supply and discharge device 11 may be able to be locked to be restricted from opening. Accordingly, it is possible to prevent the image reading device 7 from being used by a person not permitted by the administrator.

### Second Embodiment

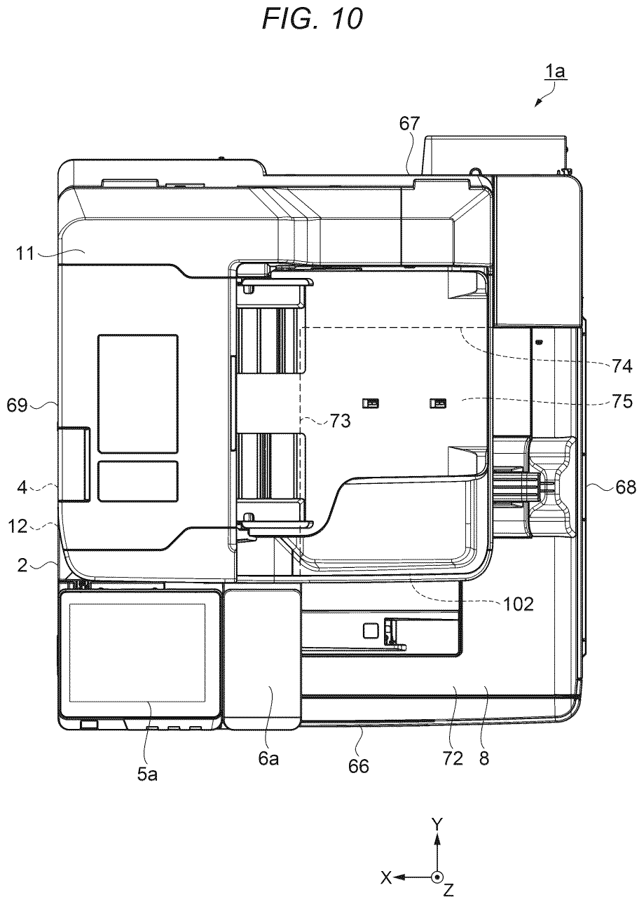

A printing apparatus 1a according to a second embodiment is explained with reference to FIG. 10. FIG. 10 is a plan view of the printing apparatus 1a according to the second embodiment.

The printing apparatus 1a according to the second embodiment includes the conveyance unit 4, the printing head 12, the apparatus main body 2, the internal discharge unit 8, an operation panel 5a, and a reading unit 6a. The operation panel 5a and the reading unit 6a are located above the apparatus main body 2 and are disposed side by side in the left-right direction in front view. The reading unit 6a is disposed on the right side with respect to the operation panel 5a. The printing apparatus 1a is the same as the printing apparatus 1 in the first embodiment except that the position of the reading unit 6a with respect to the internal discharge unit 8 is different.

The reading unit 6a is located outside the region of the internal discharge unit 8 in plan view. With the configuration explained above, the visibility and the easiness in taking out of the printing medium P in the internal discharge unit 8 are further improved. The end portion on the right side of the reading unit 6a is aligned with the first wall surface 73 in plan view.

The end portion on the front surface 66 side in the first wall surface 73 of the apparatus main body 2 is opened upward. Accordingly, when the printing medium P is taken out from the internal discharge unit 8, it is possible to prevent a hand of an operator from colliding with the reading unit 6a.

It is possible to increase a connection area of the reading unit 6a to the apparatus main body 2. Accordingly, the reading unit 6a is securely fixed to the apparatus main body 2. For that reason, for example, at the time of work of detaching the card reader 85, it is possible to prevent the reading unit 6a from falling off from the apparatus main body 2.

### Third Embodiment

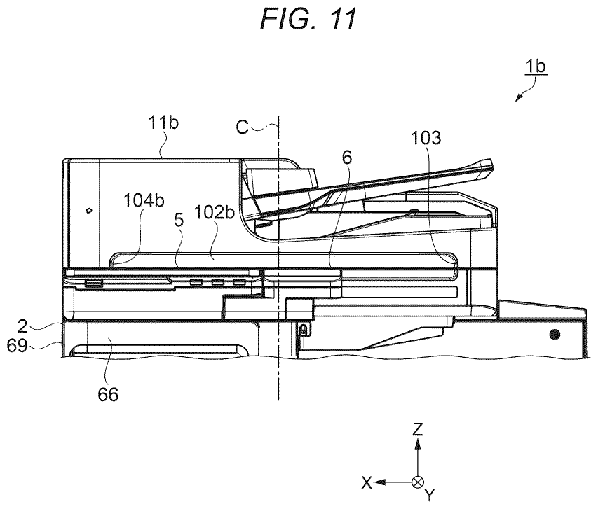

A printing apparatus 1b according to a third embodiment is explained with reference to FIG. 11. FIG. 11 is a front view illustrating the periphery of a document supply and discharge device 11b in the printing apparatus 1b according to the third embodiment.

The printing apparatus 1b according to the third embodiment includes the conveyance unit 4, the printing head 12, the apparatus main body 2, the internal discharge unit 8, the operation panel 5, the reading unit 6, the image reading device 7, and a document supply and discharge device 11b. A grip section 102b on which an operator can place his or her hand when opening the document supply and discharge device 11b is provided in the document supply and discharge device 11b. The printing apparatus 1b is the same as the printing apparatus 1 in the first embodiment except that the length of the grip section 102b in the left-right direction is different.

In the left-right direction, an end portion 104b in the left direction in the grip section 102b is located at a position overlapping the operation panel 5. The grip section 102b is disposed across a center C in the left-right direction of the document supply and discharge device 11b in front view. The length in the left-right direction of the grip section 102b is approximately 80% with respect to the length in the left-right direction of the document supply and discharge device 11b. Accordingly, the operator can easily place his or her hand on the grip section 102b.

In a state in which the operation panel 5 is laid down with respect to the apparatus main body 2, a gap more than big enough to fit a finger is provided between the grip section 102b and the operation panel 5. Accordingly, the operator can easily place his or her hand on the end portion of the operation panel 5 on the side opposite to the tilt shaft 82. Thus, the operator can easily turn the operation panel 5.

### Summary of the Present Disclosure

A summary of the present disclosure is appended below.

(Appendix 1) A printing apparatus including: a conveyance unit configured to convey a printing medium; a printing head configured to perform printing on the printing medium conveyed by the conveyance unit; an apparatus main body housing the conveyance unit and the printing head; an internal discharge unit formed in the apparatus main body, the printing medium conveyed by the conveyance unit being discharged to the internal discharge unit; an operation unit provided in the apparatus main body and configured to receive input of operation by a user; and a reading unit capable of housing a reading device configured to read information from an information medium storing the information, the reading unit being provided in the apparatus main body, wherein the operation unit and the reading unit are located above the internal discharge unit in an up-down direction and are disposed side by side in a left-right direction of the apparatus main body in front view, a medium discharge direction of the printing medium in the internal discharge unit is one direction of a left direction and a right direction in front view, the operation unit is located in another direction of the left direction and the right direction with respect to the reading unit in front view, in plan view, the operation unit is located outside a region of the internal discharge unit and at least a part of the reading unit is located outside the region of the internal discharge unit, and the operation unit and the reading unit respectively face upward.

With the configuration of Appendix 1, since the operation unit and the reading unit face upward, it is easy to cause the information medium to access the reading unit and an operation of avoiding the operation unit is unnecessary.

(Appendix 2) The printing apparatus described in Appendix 1, wherein the medium discharge direction is the right direction in front view.

With the configuration of Appendix 2, since the reading unit is located in the right direction with respect to the operation unit, it is easy to access the reading unit with the right hand and take out the printing medium.

(Appendix 3) The printing apparatus described in Appendix 1 or 2, wherein the reading unit is located outside a region of the internal discharge unit in plan view.

With the configuration of Appendix 3, the visibility and the easiness in taking out of the printing medium in the internal discharge unit are further improved.

(Appendix 4) The printing apparatus according to any one of Appendixes 1 to 3, further including: an image reading device disposed above the apparatus main body; and a document supply and discharge device disposed above the image reading device, wherein a document discharge direction of the document supply and discharge device is the same as the medium discharge direction.

With the configuration of Appendix 4, since the document discharge direction is the same as the medium discharge direction, the printing medium discharged to the internal discharge unit and the document discharged to the document supply and discharge device can be taken out by the same hand.

(Appendix 5) The printing apparatus described in Appendix 4, wherein a document setting direction of the document supply and discharge device is a direction opposite to the document discharge direction.

With the configuration of Appendix 5, since the document setting direction is the direction opposite to the document discharge direction, the document discharged to the document supply and discharge device can be taken out by a hand that has set the document in the document supply and discharge device. That is, work from the document setting to the document taking out is facilitated.

(Appendix 6) The printing apparatus described in Appendix 4 or 5, wherein the document supply and discharge device is openable and closable with respect to the image reading device, a grip section is provided in the document supply and discharge device, and the grip section is located in a region overlapping the internal discharge unit in plan view.

With the configuration of Appendix 6, the document supply and discharge device can be opened and closed by placing a hand on the document supply and discharge device at a position avoiding the operation unit and the reading unit. Thus, it is possible to easily perform work of opening and closing the document supply and discharge device.

(Appendix 7) The printing apparatus according to any one of Appendixes 4 to 6, wherein the document supply and discharge device is openable and closable with respect to the image reading device by turning around a turning shaft, the operation unit is disposed on a side opposite to the turning shaft with respect to the document supply and discharge device and is tiltable around a tilt shaft with respect to the apparatus main body, the tilt shaft is disposed on a side opposite to the document supply and discharge device with respect to the operation unit, and a gap is present between a locus drawn by an end portion of the operation unit on a side opposite to the tilt shaft and the document supply and discharge device when the operation unit is tilted.

With the configuration of Appendix 7, it is possible to improve workability when tilting the operation unit.

(Appendix 8) The printing apparatus according to any one of Appendixes 1 to 7, wherein the reading unit includes a device housing unit housing the reading device and a cover covering the device housing unit, and the cover can be locked in a state of covering the device housing unit.

With the configuration of Appendix 8, it is possible to prevent the reading device from being stolen or the reading device from being detached by a person other than the administrator.

(Appendix 9) The printing apparatus described in Appendix 8, wherein the printing apparatus includes, on an inside of the device housing unit, a connector capable of electrically connecting a wireless communication dongle.

With the configuration of Appendix 9, it is possible to connect the wireless communication dongle.

(Appendix 10) The printing apparatus according to any one of Appendixes 1 to 9, wherein the apparatus main body further includes: an ink storage unit to which an ink cartridge storing ink supplied to the printing head is attachable; and a viewing window formed on a front surface of the apparatus main body, the ink cartridge attached to the ink storage unit being visually recognizable through the viewing window, the operation unit includes a display unit capable of displaying information concerning a remaining amount of the ink in the ink cartridge, and the display unit is located above the viewing window.

With the configuration of Appendix 10, it is possible to intuitively visually recognize a cartridge that should be replaced among a plurality of ink cartridges. Accordingly, a time for replacement work can be reduced. It is possible to prevent a work mistake such as erroneous replacement.

What is claimed is:

1. A printing apparatus comprising:
a conveyance unit configured to convey a printing medium;
a printing head configured to perform printing on the printing medium conveyed by the conveyance unit;
an apparatus main body housing the conveyance unit and the printing head;
an internal discharge unit formed in the apparatus main body, the printing medium conveyed by the conveyance unit being discharged to the internal discharge unit;
an operation unit provided in the apparatus main body and configured to receive input of operation by a user; and
a reading unit capable of housing a reading device configured to read information from an information medium storing the information, the reading unit being provided in the apparatus main body, wherein
the operation unit and the reading unit are located above the internal discharge unit in an up-down direction and are disposed side by side in a left-right direction of the apparatus main body in front view,
a medium discharge direction of the printing medium in the internal discharge unit is one direction of a left direction and a right direction in front view,
the operation unit is located in another direction of the left direction and the right direction with respect to the reading unit in front view,
in plan view, the operation unit is located outside a region of the internal discharge unit and at least a part of the reading unit is located outside the region of the internal discharge unit, and
the operation unit and the reading unit respectively face upward.

2. The printing apparatus according to claim 1, wherein the medium discharge direction is the right direction in front view.

3. The printing apparatus according to claim 2, wherein the reading unit is located outside a region of the internal discharge unit in plan view.

4. The printing apparatus according to claim 3, further comprising:
an image reading device disposed above the apparatus main body; and
a document supply and discharge device disposed above the image reading device, wherein
a document discharge direction of the document supply and discharge device is the same as the medium discharge direction.

5. The printing apparatus according to claim 4, wherein a document setting direction of the document supply and discharge device is a direction opposite to the document discharge direction.

6. The printing apparatus according to claim 5, wherein
the document supply and discharge device is openable and closable with respect to the image reading device,
a grip section is provided in the document supply and discharge device, and
the grip section is located in a region overlapping the internal discharge unit in plan view.

7. The printing apparatus according to claim 5, wherein
the document supply and discharge device is openable and closable with respect to the image reading device by turning around a turning shaft,
the operation unit is disposed on a side opposite to the turning shaft with respect to the document supply and discharge device and is tiltable around a tilt shaft with respect to the apparatus main body,
the tilt shaft is disposed on a side opposite to the document supply and discharge device with respect to the operation unit, and
a gap is present between a locus drawn by an end portion of the operation unit on a side opposite to the tilt shaft and the document supply and discharge device when the operation unit is tilted.

8. The printing apparatus according to claim 1, wherein
the reading unit includes a device housing unit housing the reading device and a cover covering the device housing unit, and
the cover can be locked in a state of covering the device housing unit.

9. The printing apparatus according to claim 8, wherein the printing apparatus includes, on an inside of the device housing unit, a connector capable of electrically connecting a wireless communication dongle.

10. The printing apparatus according to claim 5, wherein
the apparatus main body further includes:
an ink storage unit to which an ink cartridge storing ink supplied to the printing head is attachable; and
a viewing window formed on a front surface of the apparatus main body, the ink cartridge attached to the ink storage unit being visually recognizable through the viewing window,
the operation unit includes a display unit capable of displaying information concerning a remaining amount of the ink in the ink cartridge, and
the display unit is located above the viewing window.
